(19) United States
(12) Patent Application Publication
(10) Pub. No.: US 2010/0279251 A1
(43) Pub. Date: Nov. 4, 2010

(54) Flexible needle housing

(75) Inventor: Gary J. Pond, Racine, WI (US)

Correspondence Address: RYAN KROMHOLZ & MANION, S.C., POST OFFICE BOX 26618, MILWAUKEE, WI, 53226, US

(73) Assignee: Inter-Med, Inc.

(21) Appl. No.: 12/387,197

(22) Filed: Apr. 29, 2009

(51) Int. Cl. A61C 3/00

(52) U.S. Cl. 433/81; 433/91

(57) ABSTRACT

A flexible or adjustable housing for a surgical needle and a needle assembly that includes the housing. Adjustment of the length of the housing allows the needle to accommodate tooth canals of varying lengths, while providing the requisite support for the needle, without needing to adjust the actual length of the needle.

### BACKGROUND OF THE INVENTION

The present invention relates to medical and dental needles and, more specifically, to housings and guards for those needles.

Endodontic or root canal therapy is a common procedure in which a dentist or endodontist removes the nerve and dental pulp from a tooth in cases where the nerve has been damaged by a cavity, trauma (e.g., fracture of the tooth), disease (e.g., infection), or other reasons. This procedure not only allows the individual to keep a tooth that otherwise might have needed removal, but relieves the individual of pain and discomfort.

When working within a root canal, a needle is used for evacuation and/or irrigation purposes. Needles are generally flexible or pliable so that they conform to the shape of the root canal. Usually the needle is inserted into the root canal until the end of the needle is a few millimeters or less from the apex of the tooth's root. This is to insure that the canal is properly debrided. However, each of the individual canals is not uniform from one to another, and the length of each individual root canal varies from canal to canal. Typically, a tooth will contain between 1-5 canals. Consequently, the length of a needle is normally adjusted to address each individual root.

The length of the needle is generally adjusted by cutting the needle to the necessary length for an individual root. Since a needle is used in multiple canals, the needle will be sized to the longest root, and then be cut down to the lengths of the other roots. However, it may not always be easy to properly assess the length of a root, or a longer root may need to be revisited during a procedure. In such instances, the shortened needle may not adequately address the longer root, which requires using a new needle. A new needle must be used, and then the needle must be properly sized, which requires extra time and, also, extra expense for the extra needles.

### SUMMARY OF THE INVENTION

The present invention provides a flexible or adjustable housing for a surgical needle and a needle assembly that includes the housing. The housing generally comprises a first section that connects the housing to a fluid line or fluid lines, such as evacuation and irrigation lines.

The housing also has a second section connected to the first section, which provides an adjustable length for the housing. Adjustment of the length of the housing allows the needle to accommodate tooth canals of varying lengths, while providing the requisite support for the needle, without needing to adjust the actual length of the needle.

### BRIEF DESCRIPTION OF THE DRAWINGS

FIG. 1 is a cross-sectional view of a typical tooth and its environment.

FIG. 2 is a cross-sectional view of the tooth of FIG. 1, with a prior art needle being inserted into a root canal of the tooth.

FIG. 3 depicts the length of a prior art needle being sized for insertion into a different root canal within the tooth.

FIG. 4 is a cross-sectional view of the needle of FIG. 3 being inserted into a second root canal of the tooth in FIG. 1.

FIG. 5 is side elevation view of a needle and housing assembly according to the present invention.

FIG. 6 is a cut-away view of the needle and housing assembly of FIG. 5 being inserted into the tooth shown in FIG. 1.

FIG. 7 is a second cut-away view of the needle and housing assembly of FIG. 5 being inserted into the other root canal of the tooth shown in FIG. 1.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

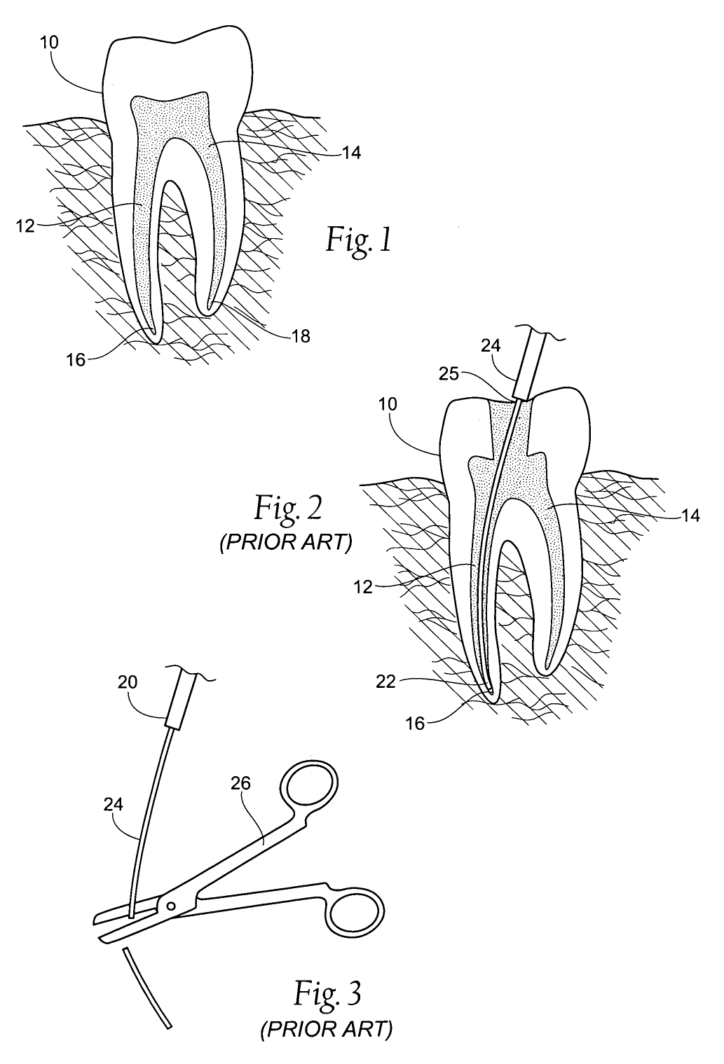

FIG. 1 depicts a typical tooth 10 for which a procedure will be performed on the tooth 10, such as a root canal or other endodontic procedure. The tooth 10 is depicted as having two root canals 12 and 14, each having a respective apex 16 and 18. The root canals 12 and 14 are shown as being of different lengths, which is typical for a tooth. For example, a tooth may have two, three, four, or five roots and root canals, with the roots ranging in a length from about 10-45 mm, or of a greater or shorter length. Regardless of the number of roots within the tooth and the length of each of the individual roots and canals, it is desirable when performing a procedure that a needle is inserted a consistent depth from the apex of an individual root, regardless of the length of the individual root canal. For example, to properly debride a root, the tip of a needle preferably would come within about 1 mm from the apex so that air pockets are not formed that inhibit the process.

FIG. 2 shows a needle 20 being inserted into the root canal 12 so that the tip 22 of the needle 20 is close (i.e. ˜<1 mm) from the apex 16. The needle 20 extends outwardly from a housing 24. Because the needle 20 is preferably a flexible or bendable, the housing 24 is necessary so that the needle 20 is properly inserted into the root canal 12 without bending or crimping prior to insertion, with the housing 24 generally being positioned or resting at or close to the top 25 of the root canal 12. Ideally, the section of the needle 20 extending outwardly from the housing 24 is only approximately the length that is necessary for the needle to reach the apex 16 (within ˜1 mm) of the root canal 12.

As previously stated, the individual root canals are of differing lengths, and the needle 20 is preferably adjusted to the specific root length. FIG. 3 shows the needle 20 being adjusted by cutting the length of the needle 20 with the use of scissors 26. The needle 20 is typically of a small enough diameter and malleable enough material that it can be cut with simple cutting devices, like scissors, utility knives, or razor blades. Alternatively, the length of the needle 20 that extends outwardly from the housing 24 can also be adjusted by cutting the housing 24 itself.

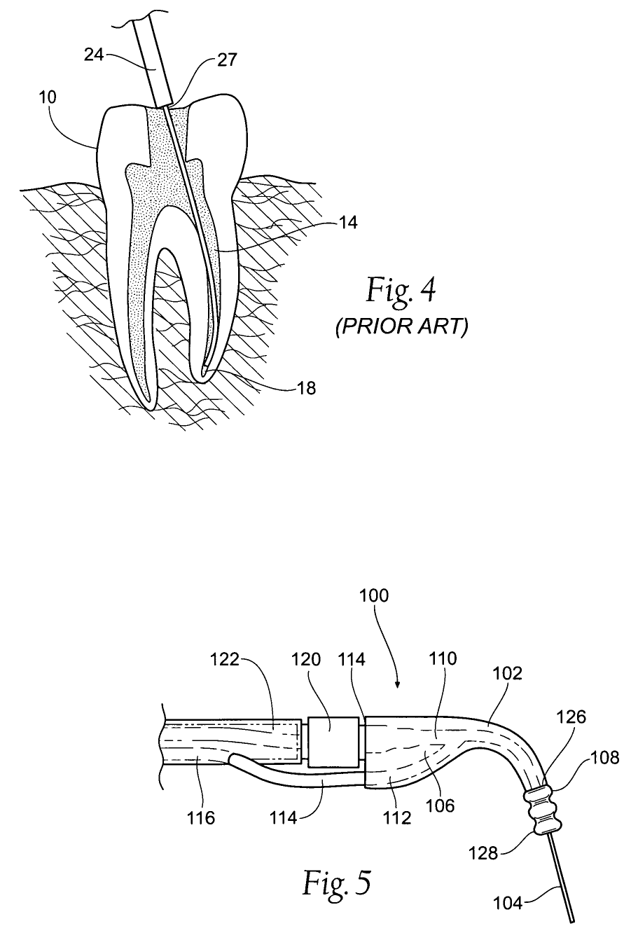

Once adjusted, the needle 20 will be inserted into the root canal 14, with the tip 22 being situated close to the apex 18 of the root canal 14, as shown in FIG. 4. The housing 24 is positioned on or near the top 27 of the root canal 14. The root canal 14 will then be debrided, and the needle 20 will be removed and can be inserted into another root canal, if necessary, with the needle 20 length to the length of the new root canal. This process can be arduous and may result in the use of more needles than necessary, particularly if a needle has been cut to the wrong length.

FIG. 5 provides a cut-away plan view of a dental assembly 100 according to the present invention. The assembly 100 alleviates the problems and time needed to adjust the length of a needle for proper insertion into a root canal. The assembly generally comprises a housing 102 with a needle 104 extending outwardly from the housing 102. The housing 102 has a first section 106 and a second section 108. The housing 102 has at least one pathway 110 for the needle 104 to be situated within and a second pathway 112 in communication with evacuation means, such as a vacuum (not shown). A tubing 114 may connect the second pathway 112 to an evacuation pathway 116, which will be connected to the evacuation source. The pathway 110 provides for fluid delivery, which may be accomplished internally or externally of the needle 104.

Still referring to FIG. 5, the first section 106 has a first end 114 that allows the housing 102 to be connected to an adaptor 120, which is subsequently connected to a handpiece 122. The arrangement allows for the needle 104 and/or the pathway 110 to be in fluid communication with a pathway 124 located within the handpiece 122. Alternatively the first end 114 may be directly connected to the handpiece 122.

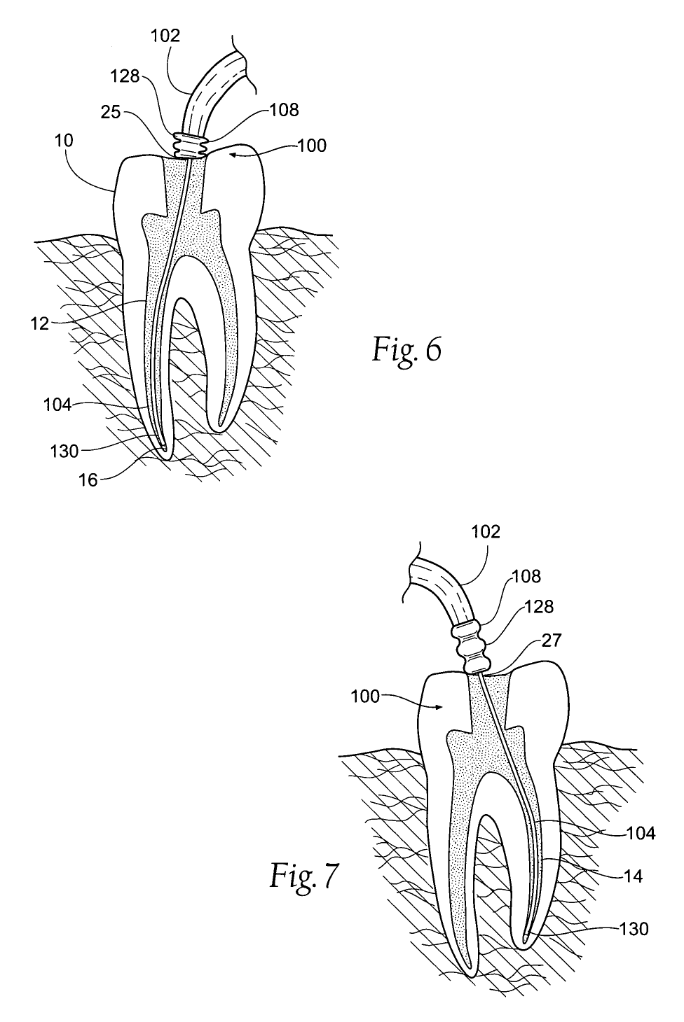

Referring further to FIG. 5, the first section 106 has a second end 126 where the first section 106 is connected to the first end 108. The first section 106 and the second section 108 can be formed as separate sections and adhered together, or they can be molded or formed as a single piece. The second section 108 comprises a flexible body 128, which will allow the overall length of the housing 102 to be adjusted. Preferably, the flexible body 128 has an accordion-style body, such as a bellows shaped area. The flexible body 128 will be discussed further with respect to FIGS. 6 and 7.

FIG. 6 demonstrates the assembly 100 being used, with the needle 104 being inserted into the root canal 12. The tip 130 of the needle 104 is positioned near the apex 16 of the root canal 12, just as the prior art needle 20 shown in FIG. 1. The flexible body 128 that generally comprises the second section 108 is buttressed against the top 25 of the root canal 12. The body 128 is compressed to allow the needle 104 to reach near the apex 16.

FIG. 7 shows the assembly 100 and the needle 104 being used in the root canal 14. The tip 130 of the needle 104 is located near the apex 18. The flexible body 128 is shown buttressed against the top 27 of the root canal 14. However, as compared to the assembly 100 as shown in FIG. 6, the body 128 is not compressed but in an extended position. In both depictions (FIGS. 6 and 7), the housing 102 provides support for the extent of the needle 104 that extends outwardly of the specific root canal 12, 14. The needle 104 is properly sized for use in either root canal 12, 14, without either the needle 104 or the housing 102 needing to be cut to size. That is, the needle 104 will be properly supported by the housing 102 while still reaching the necessary depth within a specific root canal, regardless of the length of the root canal, without any modifications necessary to the assembly 100. The arrangement not only provides for proper sizing of a needle within a root, but also provides for a quicker, more efficient process. The user does not have to measure and size the needle for different roots, which reduces the time needed for a procedure and, also, provides for a more accurate required length. Similarly, because it is not necessary to determine the length of the needle 104 in the present invention for use in a specific root canal, fewer needles will be used, which is cost effective.

This is also relevant when a user is revisiting a root where a procedure has already been performed. Because prior art needles were cut to length for each root canal, the user would need to work from the longest root canal to the shortest. Returning to a prior root canal required a new needle, as the needle being used would not have sufficient length to reach the apex of the prior, longer root canal. The present invention allows for going back to a previous root, since the overall needle length is not altered. The housing 102 is capable of adjusting to the length of each of the root canals being operated upon, while still providing the necessary support for the needle 104. The housing 102 length can be made longer or shorter, as necessary, while still being capable of returning to a different or previous housing length. The length of the adjustable portion of the housing may be adjusted, as necessary.

It is understood that the scope of the present invention is not limited by the evacuation/irrigation arrangement of the attached dental tool. For example, typically irrigation fluid is delivered to a root canal through the needle 104 and evacuated outside of the needle through the housing 102. However, there are devices and tools having an opposite arrangement, wherein irrigation fluid would be delivered through the housing, and the fluid is evacuated by the needle. The evacuation and irrigation in either arrangement may be performed simultaneous, as well. Provided that the arrangement provides for a flexible housing for the needle as disclosed, either arrangement falls under the scope of the present invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A housing for use in connection with a dental needle, said needle connected to a fluid source, the housing comprising:
a hollow main body comprising a first section and a second section, said main body receiving a portion of said dental needle;
said first section having a mating end for releasably connecting said housing to said fluid source; and
said second section having an adjustable length.

2. The housing according to claim 1 wherein said first section and second section are of unitary construction.

3. The housing according to claim 1, wherein said second section comprises a bellows.

4. A housing assembly for use in connection with a dental handpiece, said dental handpiece in connection with a fluid source, said assembly comprising:
a housing connectable to said handpiece, said housing having an adjustable length;
means for connecting said housing to said handpiece;
a needle extending from said handpiece and in fluid communication with said fluid source, wherein at least a portion of the needle being supported by said housing, said portion of said needle being supported by said housing determinative on the length of said housing.

5. The housing assembly according to claim 4 wherein said housing further comprises a hollow pathway, said hollow pathway providing support for said supported portion of said needle.

6. The housing according to claim 4 wherein said housing comprising:
a first section connectable to said handpiece; and
a second section extending from said first section, said second section providing the adjustable length for said housing.

7. A needle housing for use in connection with a dental handpiece, said housing comprising:
a first section connectable to said handpiece;
an adjustable second section connected to said first section, said second section providing an adjustable length for said housing, whereby said adjustable length supporting a respective portion of said needle.
